(19) United States
(12) Patent Application Publication
(10) Pub. No.: US 2010/0076245 A1
(43) Pub. Date: Mar. 25, 2010

(54) Pyromatic resource recovery system

(76) Inventor: Thomas Kaczmarek, Schaumburg, IL (US)

Correspondence Address: Thomas Kaczmarek, 9 Portsmouth Court, Schaumburg, IL, 60194, US

(21) Appl. No.: 12/284,264

(22) Filed: Sep. 22, 2008

(51) Int. Cl. A62D 3/40

(52) U.S. Cl. 588/321; 588/410

(57) ABSTRACT

A pyromatic system is used as a recovery system and is constructed to make the porylysis of used tires and other materials economically viable. The heart of the pyromatic system is a special stainless steel alloy reaction chamber which is mounted in a furnace box. The stainless steel alloy is known as Inconel. The reaction chamber is constructed of three tubular sections having flanges thereon. The flanges are finished to such close tolerances that no gasket are needed when the flanges are bolted together. The gaskets could not withstand the heat generated in the furnace box. Only the centrally located tubular sections is located in the furnace box. There is an auger rotating within the tubular reaction chamber to transport the shredded material there through while undergoing a pyrolisis. The auger is of the discontinuous type by heaving a multiple of cleats located in a helical pattern around a central shaft. This type of auger avoids a bunching of material while in transport and thereby eliminates hot spots in the tubular reaction chamber while maintaining an evenly distributed high temperature throughout its operation.

### BACKGROUND OF THE INVENTION

A pyrolysis system and reactor converts various hydrocarbons such as waste materials, for example, scrap polymers, tires and many others into various chemical components or amounts thereof, not otherwise produced by conventional pyrolytic processes. A large and novel reactor size is employed in association with a high heat input. It is well known that shredded pieces are transported by an auger into a pyrolysis chamber which is heated to a temperature between 350-650 degrees F. The developed vapors are withdrawn through various heat exchangers and further processed. A solid residues are transferred to various recovery bins.

### BRIEF DESCRIPTION OF THE INVENTION

The inventive pyro-matic resource recovery system has been conceived, designed and constructed to make the pyrolysis of tires and other materials economically viable. The heart of the inventive pyrolysis system is a special stainless steel alloy reaction chamber which is mounted in a furnace box. The wall of the reaction chamber is a full one inch thick and is heavily reinforced with stiffeners to prevent sagging or distortion under most extreme temperature conditions. The reactor chamber is constructed of three adjoining tubes and the tubes are connected by flanges. All flanges of the completed reactor tube are machined to very close tolerances to assure a perfect seal with a minimum or non-use of high temperature liquid gasketing or any gaskets at all. The furnace box is fabricated from a one-half inch steel plate and consists of two sections which mate at the longitudinal center line of the reactor chamber.

### BRIEF DESCRIPTION OF THE DRAWINGS

FIG. 1 is a front elevation view of the pyromatic system;

FIG. 2 is a plan view of the system;

FIG. 3 is a side elevation view of FIG. 1;

FIG. 4 is another side elevation view of FIG. 1;

FIG. 5 is a perspective view of the auger transporting material in the reactor tube;

FIG. 6 is a cross section through the auger of FIG. 5.

### DETAILED DESCRIPTION OF THE INVENTION

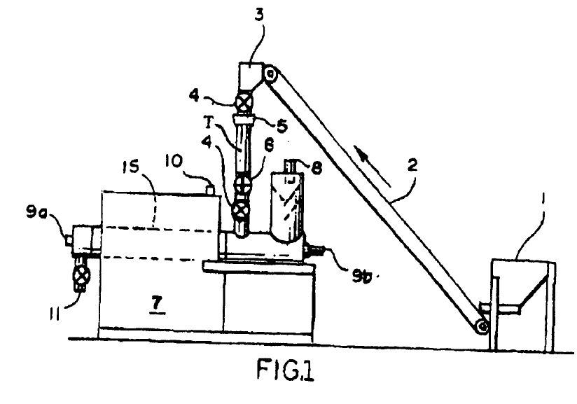

FIG. 1 is a frontal elevation view of the pyromatic system. At 1 is shown a hopper which will receive the shredded material such as shredded polymer materials as well as shredded tire pieces. From the hopper the shredded material is transported by a conveyor belt 2 to the material intake 3 which is located at the top of the system. The shredded material flows by way of gravity downwardly through the tube T including at least two air locks 4 which are instrumental to deprive the burning chamber of any oxygen. Thereby the reactor feed system operates under its vacuum system and consists of a vertical tube T with rotary air locks 4 at the top and the bottom as well as high and low sensors (not shown). Also shown is the connection 5 which is connected to a vacuum pump so that a vacuum is established in the feeder system. The feeder system also has a closure valve 6 which will maintain the vacuum in the system in the event of a shut down of the system. At the bottom of the system is a furnace box 7 which is fabricated of one-half inch steel plate and consists of two sections (not shown) which meet at the longitudinal center line of the reactor chamber.

At the heart of the pyromatic system is the special stainless steel alloy reactor chamber 15. The reactor chamber is manufactured of the super alloy stainless steel known as Inconel. This type of steel is used for gas turbine structural components, such as turbine section frames. This steel is useful where oxidation resistance and high temperature strengths are of major importance. The use of this steel has been found to be quite successful in the operation of this pyromatic system. The wall of this reaction chamber 15 is a full one inch thick and heavily reinforced with stiffeners to prevent any sagging or distortion while in operation under the most extreme temperature conditions. The reaction chamber 15 is constructed of three sections 16, 17, and 18 exhibiting flanges F, which are machined to very high tolerances, so that when either welded or bolted together, they will assure a perfect fit and no gaskets are required which would deteriorate under the high temperatures used in this system. The center tube 17 is mounted within the furnace box 15 and the other tube sections 16 and 18, which are bolted to the center tube 16 by way of bolts 15b, are placed external of the furnace box 7. One of the external tubes 18 is equipped to permit the introduction of feed stock material from the hopper 1 as well as discharge of oil loaded vapor gas at 8. The other external tube section 16 permits removal of carbon black to a cooling, conveying and collection station including a cyclone 19 (FIG. 4). The discharge of the carbon black is shown at 11 in FIG. 1.

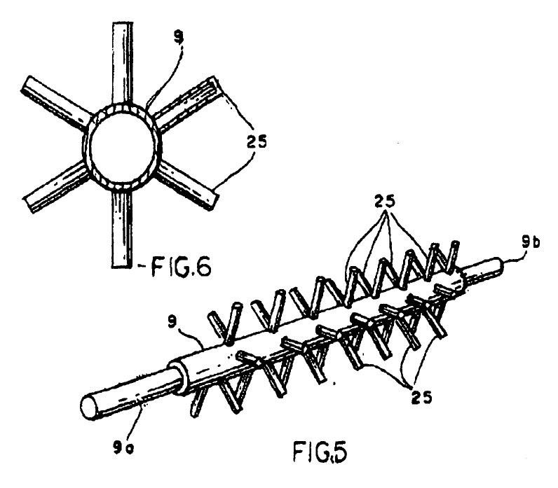

A heavy duty shaft 9 in FIGS. 5 and 6 runs the entire length of the reactor tube assembly. The tube 9 is equipped with agitator transport pins or cleats 25 which are arranged in a helical pattern around the shaft 9 to form a discontinuous auger. It has been found that it is advantageous to the helically arranged pins or cleats set around the shaft in contrast to the well known solid conveyor screws. The advantage is that the material transported through the reactor tube does not bunch up and highly heated sections are avoided. The helical pins or cleats 25 assure an even transport of the material, to be disintegrated, while at the same time still agitating the material while in transport. The ends of the rotating reactor chamber are shown at 9a and 9b. There is control system (not shown) which permits any combinations of forward or reverse cycling of the shaft 9 to precisely control retention time while providing constant agitation of the feed stock material to assure a consistent high pyrolysis product.

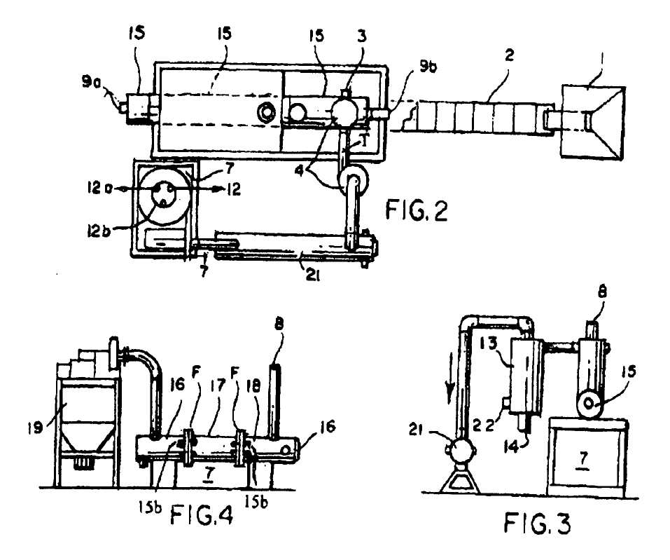

Turning now to FIG. 2, there is shown how the furnace chamber 7 receives its heat by way of burners 12, 12a, and 12b. At 12 is shown a gas burner that will deliver the heating gas to the inside of the chamber 7. At 12a there is shown a receiver end of a tube that will extricate gas from the chamber 7 and to send it to an external gas flare or to a storage system. At 12b there is shown the tube that provides the gas in to heat the content in the reactor chamber 15.

### Operation

The feed stock to be pyrolized is introduced into the system by way of a feed hopper 1. The conveyor 2 transports the feed material to the top of the pyrolysis system into a material in box 3. From there the material is transported through the feeder tube F under gravity. The air locks 4 are operated to create a vacuum in the feeder tube T and further down into the reactor chamber 15. Natural gas under normal utility residential pressure is used to bring the system to a pyrolzing temperature. Within approximately 30 minutes or less the system can be switched to the process gas produced from the feed stock. The reactor feed system operates under its own vacuum system and consists of the vertical pipe T with rotary air locks 14 at the and bottom of the tube T. The oil collection system consists of a separator (not shown), a cooling tower a cyclone 19 and a central collection tank to achieve maximum oil extraction and provide exceptionally clean manufactured gas.

What I claim is:

1. A pyromatic resource recovery system comprising: a shredded material input hopper and a conveyor for transporting said shredded material to a top of said system, a downward feeding tube conveying said shredded material to a reaction chamber by way of gravity through an air lock system, said reaction chamber is located in a furnace chamber, said reaction chamber is constructed of three tube sections, each of said tube sections having flanges thereon, means for connecting said flanges together to form said complete reaction chamber, a center of said three tube sections is located within said furnace chamber, a discontinuous auger is located inside said reactor chamber to transport the pyrolized material there through.

2. The pyromatic system of claim 1, wherein said three tube sections are made of an Inconel stainless steel.

3. The pyromatic system of claim 1, wherein said means connecting said flanges together represent bolts passing through said flanges.

4. The pyromatic system of claim 1, wherein said discontinuous auger is manufactured of a central shaft having a multiplicity of cleats arranged in a helical pattern around said shaft.

5. The pyromatic system of claim 1, wherein said pyromatic system produces gas which is utilized to heat said furnace chamber.

6. The pyromatic system of claim 1 including a cyclone located at an end of said system to cleanse oil and gas emanating from said reaction chamber.
